(19) United States
(12) Patent Application Publication
(10) Pub. No.: US 2015/0212834 A1
(43) Pub. Date: Jul. 30, 2015

(54) INTEROPERATION METHOD OF NEWTORK DEVICE PERFORMED BY COMPUTING DEVICE INCLUDING CLOUD OPERATING SYSTEM IN COULD ENVIRONMENT

(71) Applicant: ELECTRONICS AND TELECOMMUNICATIONS RESEARCH INSTITUTE, Daejeon (KR)

(72) Inventors: Sang Min LEE, Daejeon (KR); Jung Hee LEE, Daejeon (KR); Kang Il CHOI, Daejeon (KR); Bhum Cheol LEE, Daejeon (KR)

(21) Appl. No.: 14/603,974

(22) Filed: Jan. 23, 2015

(30) Foreign Application Priority Data
Jan. 24, 2014 (KR) 10-2014-0008787

(51) Int. Cl. G06F 9/445

(52) U.S. Cl. CPC G06F 9/44526; G06F 9/44505

(57) ABSTRACT

Provided is an interoperation method of a network device performed by a computing device including a cloud operating system (OS) in a cloud environment. An interoperation method of a network device based on a plug-in and performed by a computing device including a cloud OS includes acquiring control information of a different type of network device not supporting an instruction of the plug-in among network devices connected to the computing device, receiving an instruction from the cloud OS, converting the received instruction into an instruction for the network device based on the acquired control information, and providing the converted instruction to the network device. Therefore, the cloud OS can cause the computing device to simultaneously interoperate with several network devices through the plug-in.

### CLAIM FOR PRIORITY

This application claims priority to Korean Patent Application No. 2014-0008787 filed on Jan. 24, 2014 in the Korean Intellectual Property Office (KIPO), the entire contents of which are hereby incorporated by reference.

### BACKGROUND

1. Technical Field

Example embodiments of the present invention relate in general to technology of causing a cloud networking server to interoperate with network devices, and more particularly, to an apparatus and method of causing a server constituting a cloud network to simultaneously interoperate with a plurality of network devices including a virtual network device.

2. Related Art

In general, cloud computing is technology for using external physical equipment via a network, that is, technology for using and managing computing resources, such as central processing units (CPUs), memories, storages, and networks. External computing resources are used in the form of virtual machines which are virtual computing resources created with assigned physical hardware resources.

With the rapid growth of the mobile communications industry, in particular, smart phone and tablet personal computer (PC) markets, the amount of data accessible via an external network has been exponentially increased. In this environment, there are limitations to the processing of given information using only limited computing resources, and the application area of cloud computing is expanding so as to process huge data.

Using cloud computing, companies and individuals can reduce enormous cost including, for example, cost to maintain and manage computer systems, cost to purchase and install servers, update cost, and cost to purchase software, time, and human power, and also can reduce energy consumption.

Various forms of service provided by cloud computing (hereinafter referred to as “cloud services”) are generally classified into software as a service (SaaS), platform as a service (PaaS), and infrastructure as a service (IaaS). SaaS is a service which makes it possible to use functions of applications via the Internet. PaaS is a service which makes it possible to use a platform hosting applications via the Internet, and cloud service providers support service configuration components, a compatibility provision service, and so on. IaaS is a service which makes it possible to use resources for hosting applications via the Internet, and lends hardware sources to a user.

An operating system (OS) for providing a cloud service is referred to as a cloud OS. Like a general OS, the cloud OS serves as an interface between a user and a computer for providing the user with as much convenience as possible by efficiently managing computing resources, and is particularly characterized by the use of virtual computing resources (or a virtual machine).

With the increase of cloud services, the network area has rapidly expanded, and network traffic has rapidly increased. To cope with such a change of a network environment, it is necessary to efficiently use a cloud network.

In a cloud network provided by an existing cloud OS, only a virtual switch is used for communication between virtual machines. However, in order to efficiently use the cloud network, it is necessary for the cloud OS to interoperate with physical hardware network devices, such as a layer-2/layer-3 (L2/L3) switch, a router, and an open flow controller, as well as the virtual switch. Since instructions defined by respective network devices are different, interoperation methods dependent on network devices are required. To implement such interoperation functions, the cloud OS includes interoperation functions for respective network devices as plug-ins therein and converts a networking application program interface (API) transferred from a cloud networking server into instructions for the network devices.

According to an interoperation method of a network device in an existing cloud environment in which plug-ins are used as described above, it is neither possible to identify a network device which will interoperate with a cloud OS nor to issue an instruction to the network device through a networking API. Therefore, a plurality of plug-ins cannot be used at the same time, and only one plug-in can be used at a time.

### SUMMARY

Accordingly, example embodiments of the present invention are proposed to substantially obviate one or more problems of the related art as described above, and provide a method of causing a cloud operation system (OS) to interoperate with a plurality of network devices at the same time.

Other purposes and advantages of the present invention can be understood through the following description, and will become more apparent by example embodiments of the present invention. Also, it is to be understood that purposes and advantages of the present invention can be easily achieved by means disclosed in claims and a combination of them.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing a configuration of a cloud operating system (OS);

FIG. 2 is a block diagram showing an example embodiment of an interoperation structure of a cloud OS and a network device;

FIG. 3 is a block diagram showing another example embodiment of an interoperation structure of a cloud OS and a network device;

FIG. 4 is a block diagram showing an interoperation structure of a cloud OS and a network device according to an example embodiment of the present invention;

FIG. 5 is a block diagram showing an interoperation structure of a cloud OS and a network device according to another example embodiment of the present invention;

FIG. 6 is a block diagram showing an interoperation structure of a cloud OS and a network device according to still another example embodiment of the present invention;

FIG. 7 is a flowchart illustrating an interoperation process of a cloud OS and a network device according to an example embodiment of the present invention;

FIG. 8 is a flowchart illustrating an interoperation process of a cloud OS and a network device according to another example embodiment of the present invention; and

FIG. 9 is a flowchart illustrating an interoperation process of a cloud OS and a network device according to still another example embodiment of the present invention.

DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

It will be understood that, although the terms “first,” “second,” “A,” “B,” etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.). It will be understood that the term “connect” does not only denote a physical connection of an element stated herein but also denotes an electrical connection, a network connection, and so on.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, numbers, steps, operations, elements, parts and/or combinations thereof, but do not preclude the presence or addition of one or more other features, numbers, steps, operations, elements, parts, and/or combinations thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “device driver” refers to information on the corresponding hardware included in an operating, system (OS) to connect the hardware, such as a central processing unit (CPU), an input device, or an output device, and software, such as the OS or an application program, and the device driver consists of information, such as a driving method, characteristics, and functions of the hardware. According to manufacturers or detailed models, even pieces of hardware performing the same role have different driving methods and detailed functions, and information for controlling the pieces of hardware is varied. Therefore, the information is included in OSs rather than application programs to control the hardware.

Hereinafter, example embodiments of the present invention will be described in detail with reference to the accompanying drawings. To facilitate general understanding of the present invention, like numbers refer to like elements throughout the description of the drawings, and the description of the same component will not be reiterated.

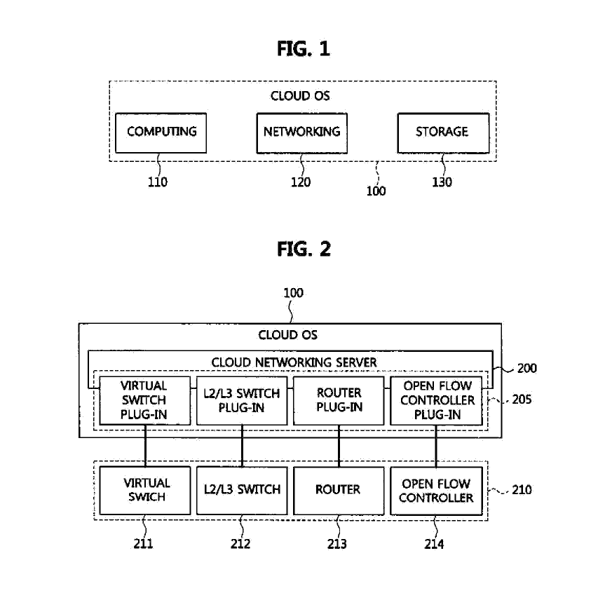

FIG. 1 is a block diagram showing a configuration of a cloud OS.

Referring to FIG. 1, a cloud OS 100 is divided into a computing portion 110 which controls a virtual machine, a networking portion 120 which controls a cloud network including a virtual switch, and a storage portion 130 which stores data required for cloud computing. Cloud services may be classified into some fields according to characteristics. However, since cloud services cover a wide range of fields, it is neither possible to specify a function for providing service nor to specify a function of the cloud OS 100 necessary to provide the service. Therefore, cloud services which can be provided by the cloud OS 100 may be extended through plug-ins. For example, when the cloud OS 100 is created for the first time, the cloud OS 100 may be designed to include a function for controlling only a network adapter, such as a virtual local area network (LAN) card, for using a physical network device of a cloud networking server but not to include a function for controlling virtual network devices, such as a virtual switch and a router, for a cloud network configuration. Here, the cloud OS 100 may add the function for controlling virtual network devices using a plug-in method, and may also expand the cloud network by controlling a network device with the added function.

Originally, a plug-in refers to a method of causing a program which cannot be executed alone to operate by making the program subordinate to another program, but generally refers to the program itself as well as the method. From now on, a program which operate subordinate to the cloud OS 100 is referred to as a “plug-in.”

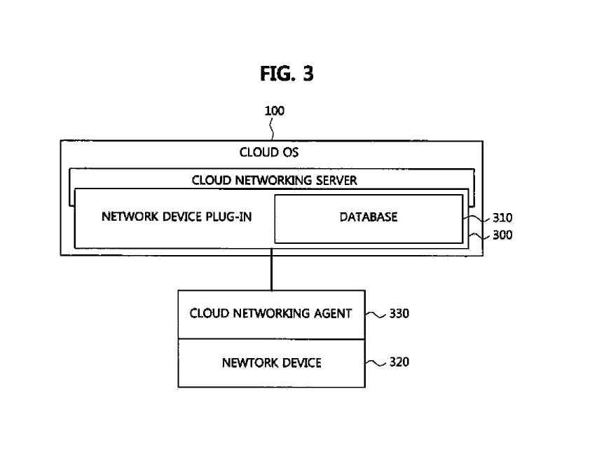

FIG. 2 is a block diagram showing an interoperation structure of network devices, that is, a structure in which each of a plurality of network devices interoperates with a cloud OS through a plug-in.

Referring to FIG. 2, a plurality of network devices 210 may be connected to a cloud networking server. Here, in order not only to physically connect the cloud networking server and the network devices 210 but also to cause the cloud networking server to logically intemperate with the network devices 210, a cloud OS 100 which controls the cloud networking server is required to control the network devices 210. Therefore, for convenience, it will be described below that the cloud OS 100 instead of the cloud networking server interoperates with the network devices 210.

As described with reference to FIG. 1, the cloud OS 100 may control the network devices 210 through plug-ins 205. The respective network devices 210 may be controlled by (or interoperate with) the cloud OS 100 through the plug-ins 205 specialized therefor. Here, the network devices 210 may include a virtual network device, such as a virtual switch 211, and various physical network devices, such as a layer-2/layer-3 (L2/L3) switch 212, a router 213, and an open flow controller 214.

The cloud OS 100 operates in at least one cloud networking server 200. When the cloud OS 100 operates in a plurality of cloud networking servers 200, each of the cloud networking servers 200 may include a network adapter. The cloud networking servers 200 are connected to other network devices through their network adapters, thereby constituting a network therebetween. Therefore, a plurality of network devices may operate as one system. Here, the cloud OS 100 may not only include the network adapters and the physical network devices but also include a virtual network, adapter and a virtual network device. Therefore, it is possible to expand the network regardless of physical limitations of the cloud networking server 200.

The cloud OS 100 can control the network devices through an application program interface (API) consisting of a set of subroutines or functions. Since an API is a set of instructions for general-use functions for operation of an OS, the OS needs to convert the API into instructions which can be understood by network devices so as to control the network devices. The cloud OS 100 can combine or convert instructions (or functions) defined in the API according to the network devices 210 through the plug-ins 205.

Here, when the respective network devices 210 interoperate with the cloud OS 100 through the plug-ins 205, the cloud OS 100 may provide instructions to the plug-ins 205 to control the interoperating network devices 210. Here, since the instructions are for general use, each plug-in may receive the same instruction from the cloud OS 100 and transfer the received instruction to a network device specified therefor. Therefore, the same operation may be performed by all the network devices 210. In order to prevent such duplication of operation, only one plug-in needs to operate at a time.

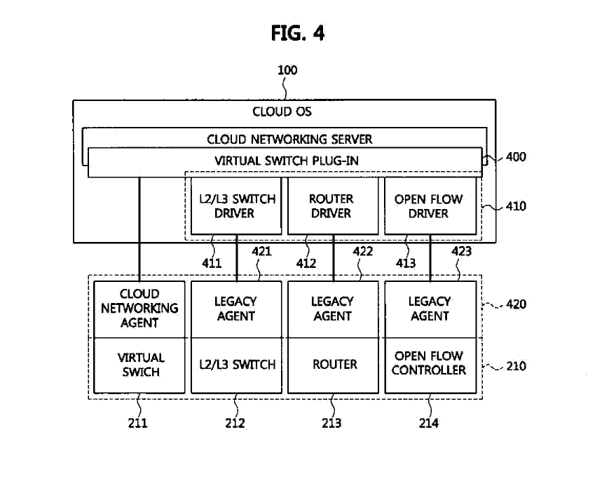

FIG. 3 is a block diagram showing an interoperation structure of a network device, that is, a structure in which a network device interoperates with a cloud OS through a plug-in.

Referring to FIG. 3, a plug-in 300 may include a database 310, and a network device 320 may include an agent 330. The database 310 may store information on installation and removal of the interoperating network device 320.

The agent 330 may process instructions transferred through the plug-in 300.

A cloud OS 100 may manage and monitor the network device 320 through the agent 330. For example, when the cloud OS 100 manages and monitors the network device 320 using a simple network management protocol (SNMP), the network device 320 may include an SNMP agent, and the SNMP agent may provide information on the network device 320 to the cloud OS 100.

FIG. 4 is a block diagram showing an interoperation structure of a network device according to an example embodiment of the present invention, that is, a structure in which a plurality of network devices interoperate with a cloud OS using one plug-in.

Referring to FIG. 4, an interoperation structure of a plurality of virtual and physical network devices and a cloud OS 100 may include one plug-in 400 and a plurality of device drivers 410 connected to the plug-in 400.

The cloud OS 100 may interoperate with a virtual network device 211 though the plug-in 400, and may interoperate with physical network devices 212, 213, and 214 through the plug-in 400 and the device drivers 410. Here, each network device may understand an instruction provided from the interoperating cloud OS 100 through an agent.

As shown in FIG. 2, the cloud OS 100 needs plug-ins to interoperate with network devices. However, the cloud OS 100 can neither identify a plug-in nor issue an instruction to an API, and thus needs to interoperate with a plurality of network devices using the only one plug-in 400. The one plug-in is referred to as a “representative plug-in.”

The representative plug-in 400 converts an instruction provided from the cloud OS 100 into an instruction which is supported (or can be understood) by network devices 210, and provides the converted instruction to the network devices 210.

While an existing plug-in supports a specific network device, the representative plug-in 400 can support various unspecific network devices.

Here, instructions that can be understood by the respective network devices 210 may be different according to hardware or software characteristics of the network devices 210. Therefore, the representative plug-in 400 needs information for controlling a specific network device (hereinafter referred to as “control information”). The control information may include information on instructions that can be understood by the specific network device.

The representative plug-in 400 supports various network devices and thus needs control information of all network devices connected to the cloud OS 100. However, due to several practical limitations, the representative plug-in 400 can neither include control information of all network devices present when the representative plug-in 400 is created nor predict a network device which will be connected in the future. Therefore, the representative plug-in 400 may be provided with control information of a connected network device by a network device provider, an administrator of the cloud OS 100, etc., and may cause the cloud OS 100 to interoperate with the network device. The control information may be included in a device driver.

Since the representative plug-in 400 transfers an instruction according to characteristics of connected network devices 210, the duplication of the instruction caused in the interoperation structure shown in FIG. 2 does not occur.

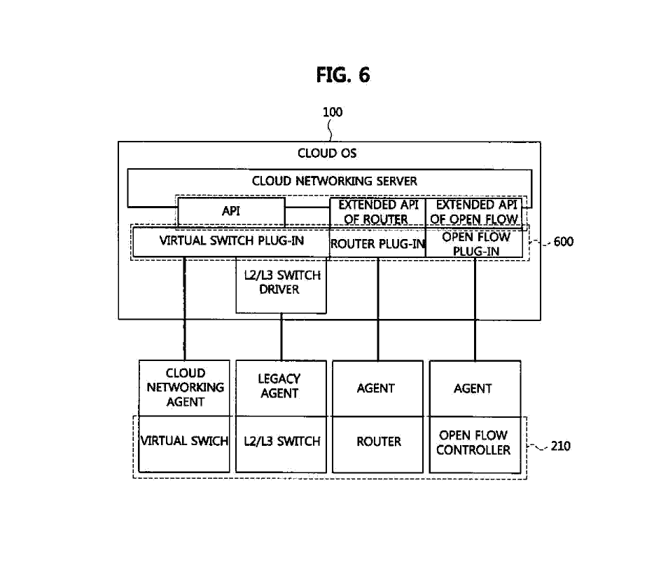

The physical network devices 212, 213, and 214 are connected to the representative plug-in 400 through device drivers 411, 412, and 413 respectively to interoperate with the cloud OS 100, and thus cannot implement a function that is not supported by the representative plug-in 400. For example, when the representative plug-in 400 supports only a switch function, a router connected to the representative plug-in 400 only supports communication between terminals belonging to the same network (or networks having the same subnet mask), but cannot support communication between terminals belonging to different networks. In another example, when the representative plug-in 400 does not support a controller function of a network device, an open flow controller connected to the representative plug-in 400 may not perform the function. Therefore, the cloud OS 100 needs a new plug-in to control a network device which supports a new function. An interoperation method using a plurality of plug-ins will be described later with reference to FIG. 6.

Here, the cloud OS 100 may transfer an instruction to the network devices 210 through a previously given protocol.

The network devices 210 can process the instruction transferred through the protocol using agents 420. At this time, the physical network devices 212, 213, and 214 use an existing protocol as it is, and thus it is possible to use existing agents 421, 422, and 423 as they are. For example, assuming that the cloud OS 100 interoperates with an L2/L3 switch through the representative plug-in 400 and the device drivers 410 and a protocol for the interoperation is the SNMP, the L2/L3 switch can use an existing SNMP agent as it is without modification for the interoperation with the cloud OS 100.

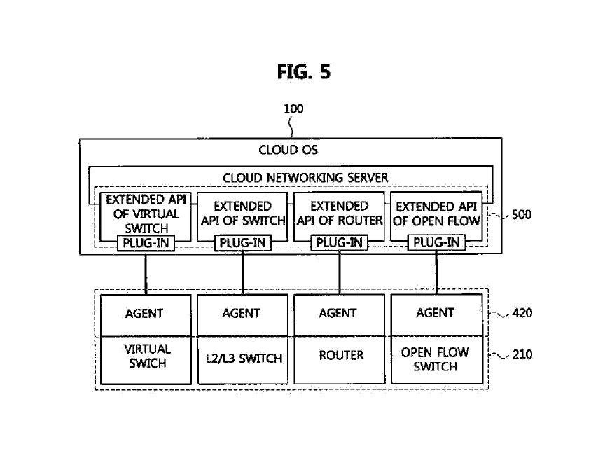

FIG. 5 is a block diagram showing an interoperation structure of a network device according to an example embodiment of the present invention, that is, a structure in which a cloud OS interoperates with a plurality of network devices using extended APIs.

Referring to FIG. 5, in an interoperation structure in which a cloud OS 100 interoperates with a plurality of network devices 210, the cloud OS 100 may include extended APIs 500 specialized for the respective network devices 210. Also, the respective network devices 210 may include agents 420 to interoperate with the cloud OS 100 through the extended APIs 500.

As described with reference to FIG. 2, an API is a set of instructions implemented in a general-use form in consideration of several types of network devices, and thus the network devices 210 may not directly understand instructions of APIs provided by a cloud OS. However, when the cloud OS 100 defines the extended APIs 500 which can be understood by specific network devices using control information of the network devices and provides an extended instruction, the network devices can directly understand the provided extended instruction. For example, when an instruction of an existing API to add a new, network device to the cloud OS 100 is “create_network,” the cloud OS 100 may provide extended instructions in the form of “virtual_switch_create_network,” “1213 create_network,” “router_create_network,” “openflow_create_network,” and so on.

Since the extended APIs 500 merely enable the cloud OS 100 to directly provide functions of plug-ins, an interoperation method using the extended APIs 500 can use an existing protocol and the agents 420 as they are, like an interoperation method using plug-ins.

The extended APIs 500 are included in the cloud OS 100 and thus can be defined in consideration of virtual and physical network devices present when the cloud OS 100 is created. Also, by modifying functions of the cloud OS 100, extended APIs 500 may be added for network devices which are not taken into consideration when the cloud OS 100 is created. For example, the cloud OS 100 can generate extended APIs 500 by itself using control information of network devices included in installed plug-ins or device drivers. Also, it is possible to add an extended API in various ways, such as a version upgrade, an extension pack, or a service pack of the cloud OS 100. Further, by standardizing a variety of predetermined extended APIs 500, it is possible to manufacture network devices capable of using the extended APIs 500 instead of adding extended APIs 500 according to the network devices.

Unlike existing APIs, the extended APIs 500 enable identification of network devices. Therefore, even when the cloud OS 100 interoperates with network devices through plug-ins using the extended APIs 500, a plurality of network devices neither receive the same instruction nor perform the same operation.

FIG. 6 is a block diagram showing an interoperation structure of a cloud OS and a network device according to an example embodiment of the present invention, that is, a structure in which a cloud OS interoperates with a plurality of network devices using extended APIs and a device driver.

Referring to FIG. 6, using a combination of the structure shown in FIG. 4 and the structure shown in FIG. 5, it is possible to expand the use range of an interoperation structure of a cloud OS 100 and network devices 210.

In the interoperation structure shown in FIG. 4, the cloud OS 100 can interoperate with a plurality of network devices through one plug-in, but functions that can be performed by the cloud OS 100 may be limited due to the use of only one plug-in. Therefore, the cloud OS 100 can generate an extended API for each of a plurality of plug-ins 600 and transfer an instruction to a network device, like in the interoperation structure of FIG. 5 in which extended APIs are used for network devices. Also, each plug-in 600 can control the plurality of network devices 210 using the interoperation structure of FIG. 4 in which device drivers of network devices are used. Therefore, the cloud OS 100 can control network devices supporting various functions regardless of types or the number of network devices.

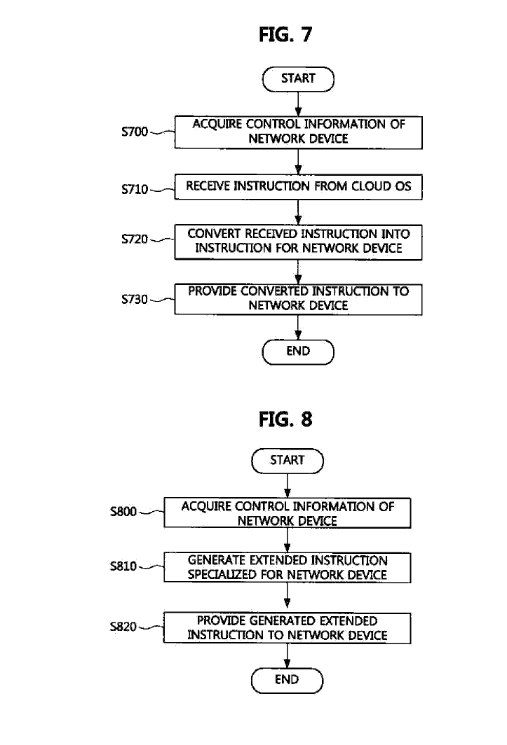

FIG. 7 is a flowchart illustrating an interoperation process of a cloud OS and a network device according to an example embodiment of the present invention.

It is assumed that a cloud OS operates in a computing device, and a plug-in is installed in the OS and controls at least one network device.

Referring to FIG. 7, when it is sensed that a network device supporting instructions other than instructions provided by the plug-in is connected to the cloud OS, the plug-in may acquire control information of the connected network device (S700).

At this time, the plug-in may store the acquired control information and installation information of the network device in a database. Therefore, once information is acquired from a network device, even if the network device is removed from and reinstalled in a cloud OS, the plug-in needs not acquire control information.

Next, the plug-in may receive an instruction from the cloud OS (S710).

Next, the plug-in may convert the received instruction into an instruction for the network device based on the control information (5720).

Next, the plug-in may provide the converted instruction to the network device (S730).

Here, the converted instruction is for the specific network device, and thus the plug-in can identify the network device to provide the instruction.

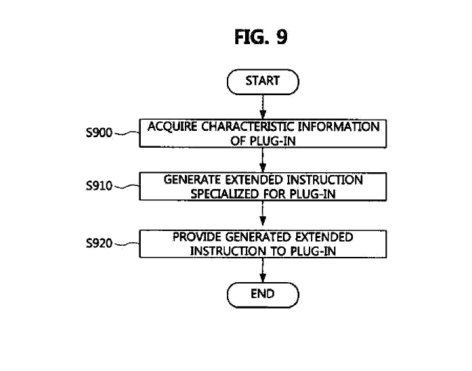

FIG. 8 is a flowchart illustrating an interoperation process of a cloud OS and a network device according to another example embodiment of the present invention.

Referring to FIG. 8, when it is sensed that a network device supporting instructions other than instructions provided by a cloud OS is connected, the cloud OS may acquire control information of the sensed network device (S800).

At this time, the cloud OS may acquire the control information through a device driver.

Also, the cloud OS may store the acquired control information and installation information of the network device in a database. Therefore, once information is acquired from a network device, even if the network device is removed from and reinstalled in a cloud OS, a plug-in needs not acquire control information.

Next, the cloud OS may generate an extended instruction for the specific network device based on the acquired control information (S810). Instructions that can be provided by the cloud OS are included in an API defined in advance when the cloud OS is created, and thus the cloud OS can generate an extended API including extended instructions.

Next, the cloud OS may provide the generated extended instruction to the network device (S820).

Here, the generated extended instruction is specialized for the one network device, and thus the cloud OS does not provide the same instruction to all network devices connected thereto and can provide the instruction to only the specific network device.

FIG. 9 is a flowchart illustrating an interoperation process of a network device according to an example embodiment of the present invention.

Referring to FIG. 9, when a plug-in which cannot be identified by a cloud OS is installed in the cloud OS operating in a computing device, the cloud OS may acquire plug-in characteristic information (S900).

Interoperation methods described with reference to FIGS. 7 and 8 are intended for a cloud OS to transfer an instruction to a network device. However, the network device cannot directly understand the instruction of the cloud OS, and the cloud OS needs control information of the network device. On the other hand, a method described with reference to FIG. 9 is intended for a cloud OS to transfer an instruction to a plug-in, and the cloud OS may not need control information of the plug-in because the plug-in can directly understand the instruction of the cloud OS. Instead, the cloud OS needs characteristic information of installed plug-ins to distinguish the plug-ins from each other. Characteristic information may include various pieces of information for distinguishing one plug-in from other plug-ins, such as names and types of the plug-ins.

Next, the cloud OS may generate an extended instruction specialized for the plug-in (S910). Also, as described with reference to FIG. 8, the cloud OS may generate an extended API.

Next, the cloud OS may provide the generated extended instruction to the network device to control the network device (S920).

According to the above-described interoperation apparatus and method of a network device in a cloud environment, a plug-in is used for one network device, and device drivers are used for other network devices. Therefore, a cloud OS can cause a cloud networking server to interoperate with a plurality of virtual and physical network devices at the same time.

In particular, the cloud OS uses the device drivers for interoperation of the other network devices, and thus it is possible not to modify the existing network device.

Also, the cloud OS can expand the use range of a network interoperation structure by interoperating with network devices through extended APIs.

While the example embodiments of the present invention and their advantages have been described in detail, it should be understood that various changes, substitutions and alterations may be made herein without departing from the scope of the invention.

What is claimed is:

1. An interoperation method of a network device based on a plug-in and performed by a computing device including a cloud operating system (OS) in a cloud environment, the interoperation method comprising:
acquiring control information of a different type of network device not supporting an instruction of the plug-in among network devices connected to the computing device; and
generating instructions specialized for the different type of network device based on the control information.

2. The interoperation method of claim 1, wherein the control information includes information on instructions supported by the different type of network device.

3. The interoperation method of claim 2, wherein the acquiring of the control information comprises acquiring the control information from a device driver of the different type of network device.

4. The interoperation method of claim 1, further comprising, after the generation of the instructions, storing interoperation relationship information of the different type of network device and the cloud OS.

5. The interoperation method of claim 1, further comprising, after the generation of the instructions, when an instruction is received from the cloud OS, providing an instruction corresponding to the received instruction among the generated instructions to the different type of network device.

6. The interoperation method of claim 5, wherein the providing of the instruction comprises providing the instruction through a protocol supported by the different type of network device.

7. The interoperation method of claim 6, wherein the providing of the instruction comprises providing the instruction to an agent included in the different type of network device through the protocol.

8. The interoperation method of claim 1, wherein the different type of network device is a physical network device.

9. An interoperation method of a network device performed by a computing device including a cloud operating system (OS) in a cloud environment, the interoperation method comprising;
acquiring control information of each of at least one network device connected to the computing device; and
generating an extended application program interface (API) specialized for the network device based on the control information.

10. The interoperation method of claim 9, wherein the control information includes information on instructions supported by the network device.

11. The interoperation method of claim 10, wherein the acquiring of the control information comprises acquiring the control information from a device driver of the network device.

12. The interoperation method of claim 9, wherein the generation of the extended API comprises generating extended instructions constituting the extended API.

13. The interoperation method of claim 12, wherein the extended instructions reflect information instructing the network device.

14. The interoperation method of claim 9, further comprising, after the generation of the extended API, when there is an instruction to be provided to the network device, specifying a network device to be provided with the instruction, and providing the instruction to an extended API specialized for the specified network device.

15. The interoperation method of claim 9, wherein the at least one network device includes a physical network device.

16. An interoperation method of a network based on a plurality of plug-ins and performed by a computing device including a cloud operating system (OS) in a cloud environment, the interoperation method comprising:
acquiring characteristic information of each of the plug-ins providing instructions to network devices; and
generating extended application program interfaces (APIs) specialized for the respective plug-ins based on the acquired characteristic information.

17. The interoperation method of claim 16, wherein the generating of the extended APIs comprises generating extended instructions constituting the extended APIs.

18. The interoperation method of claim 17, wherein the extended instructions reflect information instructing the plug-ins.

19. The interoperation method of claim 16, further comprising, after the generation of the extended APIs, when there is an instruction to be provided to a network device, specifying a plug-in to provide the instruction, and providing the instruction to an extended API specialized for the specified plug-in.
